(19) United States
(12) Patent Application Publication
(10) Pub. No.: US 2026/0331122 A1
(43) Pub. Date: Oct. 22, 2026

(54) REVERBERATION CONTROLLABLE SPEECH RESTORATION MODEL

(71) Applicant: GDM Holding LLC, Mountain View, CA (US)

(72) Inventors: Yuma Koizumi, Tokyo (JP); Robin Scheibler, Hino (JP); Haruko Ishikawa, Tokyo (JP); Shigeki Karita, Tokyo (JP); Wataru Nakata, Mountain View, CA (US); Byungha Chun, Tokyo (JP)

(73) Assignee: GDM Holding LLC, Mountain View, CA (US)

(21) Appl. No.: 19/572,778

(22) Filed: Mar. 19, 2026

Related U.S. Application Data
(60) Provisional application No. 63/792,874, filed on Apr. 22, 2025.

(51) Int. Cl. G10L 21/0216; G10L 21/0208

(52) U.S. Cl. CPC G10L 21/0216; G10L 2021/02082

(57) ABSTRACT

A method includes receiving noisy audio data containing sound degradation factors. The sound degradation factors including noise and characteristics of reverberation present in the noisy audio data. The method includes receiving reverberant audio data containing characteristics of reverberation. The method includes processing, using a feature cleaner component, the noisy audio data to extract clean audio features from the noisy input audio that remove the sound quality degradation factors from the noisy audio data, and in parallel, processing, using a reverb encoder, the reverberant audio data to extract reverb features that retain the characteristics of reverberation contained in the reverberant audio data. The method includes generating, as output from a vocoder model conditioned on both the clean audio features and the reverb features, an output audio waveform.

### CROSS REFERENCE TO RELATED APPLICATIONS

This U.S. patent application claims priority under 35 U.S.C. § 119(e) to U.S. Provisional Application 63/792,874, filed on Apr. 22, 2025. The disclosure of this prior application is considered part of the disclosure of this application and is hereby incorporated by reference in its entirety.

### TECHNICAL FIELD

This disclosure relates to a reverberation controllable speech restoration model.

### BACKGROUND

Speech restoration (SR) is a technology aimed at converting audio data, degraded in quality by various factors, into high-quality data akin to that recorded in a professional studio. In the conventional context of speech restoration, “high-quality data” refers to audio completely free from factors that impair sound quality, such as noise, reverberation, and distortions from data compression. Advances in SR research utilizing generative models have enabled state-of-the-art SR models to output such “high-quality data.” Furthermore, using these models to clean training data for other speech generation models has empowered those subsequent models to generate new, high-fidelity audio.

### SUMMARY

One aspect of the disclosure provides a computer-implemented method executed on data processing hardware that causes the data processing hardware to perform operations for controlling reverberation using a speech restoration (SR) model. The operations include receiving noisy audio data containing sound degradation factors. The sound degradation factors include noise and characteristics of reverberation present in the noisy audio data. The operations include receiving reverberant audio data containing characteristics of reverberation. The operations also include processing, in parallel, the noisy audio data to extract clean audio features from the noisy input audio that remove the sound quality degradation factors from the noisy audio data using a feature cleaner component and the reverberant audio data to extract reverb features that retain the characteristics of reverberation contained in the reverberant audio data using a reverb encoder. The operations include generating, as output from a vocoder model conditioned on both the clean audio features and the reverb features, an output audio waveform that removes the sound quality degradation factors from the noisy audio data and retains the characteristics of reverberation contained in the reverberant audio data.

Implementations of the disclosure may include one or more of the following optional features. In some implementations, the reverberant audio data includes the same audio data as the noisy audio data. In some examples, the reverberant audio data includes different audio data than the noisy audio data. Here, the characteristics of reverberation contained in the reverberant audio data may be different than the characteristics of reverberation present in the noisy audio data. In some implementations, the reverb encoder includes a stack of self-attention layers. The stack of self-attention layers may include Conformer layers or Transformer layers.

In some examples, the feature cleaner component includes a pre-trained audio encoder implementing an adapter module to adapt the pre-trained audio encoder to extract the clean audio features from the noisy audio data. The pre-trained audio encoder may be pre-trained on various types of audio data via an unsupervised or self-supervised pre-training process. Here, the various types of audio include real-world noisy data, simulated noisy data, and dry sources that do not contain any sound degradation factors. In these examples, a fine-tuning process may train the feature cleaner component by obtaining a clean audio training sample including a corresponding noisy data input paired with a corresponding ground-truth dry source, processing the noisy data input to extract predicted clean features using the pre-trained audio encoder implementing the adapter module, processing the ground-truth dry source to extract target clean features using only the pre-trained audio encoder, determining a fine-tuning loss based on the predicted clean features and the target clean features, and updating parameters of the adapter module while parameters of the pre-trained audio encoder are held fixed to teach the feature cleaner component to extract clean features that match the target clean features. The ground-truth dry source removes sound degradation factors present in the noisy data input. The pre-trained audio encoder may include a stack of multi-head attention layers.

In some implementations, a reverberation training process trains the feature cleaner component, the reverb encoder, and the vocoder model by: obtaining a reverberant audio training sample that includes a corresponding noisy data input, a corresponding ground-truth dry source that removes sound degradation factors present in the noisy data input, and a ground-truth reverberant audio waveform derived from the ground-truth dry source by convolving the ground-truth dry source; processing the noisy data input to extract clean features from the noisy data input using the pre-trained audio encoder implementing the adapter module; processing the noisy data input to extract reverb features from the noisy data input using the reverb encoder; generating an output training audio waveform as output from the vocoder model conditioned on both the clean features and the reverb features; determining a reverberation loss based on the training audio waveform and the ground-truth reverberant audio waveform; and updating parameters of the reverb encoder and the vocoder model based on the reverberation loss.

Another aspect of the disclosure provides a system that includes data processing hardware and memory hardware storing instructions that when executed on the data processing hardware causes the data processing hardware to perform operations. The operations include receiving noisy audio data containing sound degradation factors. The sound degradation factors include noise and characteristics of reverberation present in the noisy audio data. The operations include receiving reverberant audio data containing characteristics of reverberation. The operations also include processing, in parallel, the noisy audio data to extract clean audio features from the noisy input audio that remove the sound quality degradation factors from the noisy audio data using a feature cleaner component and the reverberant audio data to extract reverb features that retain the characteristics of reverberation contained in the reverberant audio data using a reverb encoder. The operations include generating, as output from a vocoder model conditioned on both the clean audio features and the reverb features, an output audio waveform that removes the sound quality degradation factors from the noisy audio data and retains the characteristics of reverberation contained in the reverberant audio data.

Implementations of the disclosure may include one or more of the following optional features. In some implementations, the reverberant audio data includes the same audio data as the noisy audio data. In some examples, the reverberant audio data includes different audio data than the noisy audio data. Here, the characteristics of reverberation contained in the reverberant audio data may be different than the characteristics of reverberation present in the noisy audio data. In some implementations, the reverb encoder includes a stack of self-attention layers. The stack of self-attention layers may include Conformer layers or Transformer layers.

In some examples, the feature cleaner component includes a pre-trained audio encoder implementing an adapter module to adapt the pre-trained audio encoder to extract the clean audio features from the noisy audio data. The pre-trained audio encoder may be pre-trained on various types of audio data via an unsupervised or self-supervised pre-training process. Here, the various types of audio include real-world noisy data, simulated noisy data, and dry sources that do not contain any sound degradation factors. In these examples, a fine-tuning process may train the feature cleaner component by obtaining a clean audio training sample including a corresponding noisy data input paired with a corresponding ground-truth dry source, processing the noisy data input to extract predicted clean features using the pre-trained audio encoder implementing the adapter module, processing the ground-truth dry source to extract target clean features using only the pre-trained audio encoder, determining a fine-tuning loss based on the predicted clean features and the target clean features, and updating parameters of the adapter module while parameters of the pre-trained audio encoder are held fixed to teach the feature cleaner component to extract clean features that match the target clean features. The ground-truth dry source removes sound degradation factors present in the noisy data input. The pre-trained audio encoder may include a stack of multi-head attention layers.

In some implementations, a reverberation training process trains the feature cleaner component, the reverb encoder, and the vocoder model by: obtaining a reverberant audio training sample that includes a corresponding noisy data input, a corresponding ground-truth dry source that removes sound degradation factors present in the noisy data input, and a ground-truth reverberant audio waveform derived from the ground-truth dry source by convolving the ground-truth dry source; processing the noisy data input to extract clean features from the noisy data input using the pre-trained audio encoder implementing the adapter module; processing the noisy data input to extract reverb features from the noisy data input using the reverb encoder; generating an output training audio waveform as output from the vocoder model conditioned on both the clean features and the reverb features; determining a reverberation loss based on the training audio waveform and the ground-truth reverberant audio waveform; and updating parameters of the reverb encoder and the vocoder model based on the reverberation loss.

The details of one or more implementations of the disclosure are set forth in the accompanying drawings and the description below. Other aspects, features, and advantages will be apparent from the description and drawings, and from the claims.

### DESCRIPTION OF DRAWINGS

FIGS. 1A-1C are schematic views of an example system including a speech restoration model with controllable reverberation.

FIG. 2 is a schematic view of a speech restoration model with controllable reverberation.

FIG. 3 is a schematic view of an example fine-tuning process for training a feature cleaner component of the speech restoration model of FIG. 2.

FIGS. 4A and 4B are schematic views of an example reverberation training process for training the speech restoration model of FIG. 2 to generate output audio waveforms that retain characteristics of reverberation.

FIG. 5 is a flowchart of an example arrangement of operations for a computer-implemented method for controlling reverberation using a speech restoration model.

FIG. 6 is a schematic view of an example computing device that may be used to implement the systems and methods described herein.

Like reference symbols in the various drawings indicate like elements.

### DETAILED DESCRIPTION

Speech restoration (SR) is a technology aimed at converting audio data, degraded in quality by various factors, into high-quality data akin to that recorded in a professional studio. In the conventional context of speech restoration, “high-quality data” refers to audio completely free from factors that impair sound quality, such as noise, reverberation, and distortions from data compression. Advances in SR research utilizing generative models have enabled state-of-the-art SR models to output such “high-quality data.” Furthermore, using these models to clean training data for other speech generation models has empowered those subsequent models to generate new, high-fidelity audio.

However, certain acoustic characteristics traditionally removed by SR are crucial for realism in many applications. Specifically, reverberation is the phenomenon resulting from the combination of multiple sound reflections and diffractions within an environment that inherently encodes spatial information about the space where speech originates. This spatial information is crucial for spatial perception, significantly influencing how listeners perceive the acoustic scene. Consequently, completely removing reverberation can lead to unnatural results for media creative purposes. For example, in a video featuring someone speaking inside a large cathedral, if the accompanying audio lacks reverberation, the overall presentation becomes incongruous and artificial. Thus, in scenarios where a content creator wants to clean noisy audio recorded in a specific environment (e.g., a cathedral) while preserving its characteristic ambiance, applying conventional SR models is problematic, as the creator would ultimately eliminate the desired reverberation along with the unwanted noise.

With the significant progress in generative artificial intelligence (AI) for images, video, and audio, there is a growing need for SR technologies that can better contribute to realistic media generation. To achieve realistic media generation, SR technologies must move beyond simply eliminating all degradation factors, and instead, should allow for the selective removal, control, or modification of these factors based on a target outcome.

Implementations herein are directed toward an SR model having an architecture that provides the capability to control reverberation in modified audio output by the SR model from original input audio in a manner independent of removing other noise factors such that existing reverberation that was present in the original input audio can be preserved in the modified audio, the existing reverberation can be replaced with different reverberation in the modified audio, or new reverberation appropriate for a context of the modified audio can be synthesized.

The SR model includes a feature cleaner component that includes an audio encoder pre-trained on a vast amount of speech data that implements a parallel adapter module to adapt the pre-trained audio encoder to encode clean audio features from noisy input audio that removes sound quality degradation factors such as noise and reverberation present in the noisy input audio. A reverb encoder utilized in parallel with the feature cleaner component modifies the architecture of the SR model for controllable reverberation capabilities. Here, the reverb encoder is configured to extract reverb features that retain the characteristics of reverberation from the audio input to the reverb encoder. A vocoder model receives the clean audio features encoded by the audio encoder and the reverb features predicted by the reverb encoder such that the reverb features condition the vocoder model to generate an output audio waveform that removes the sound quality degradation factors present in the noisy input audio while retaining the characteristics of reverberation. When the output audio waveform to be generated by the vocoder model is to remove all reverberation, the reverb encoder simply outputs a zero vector instead of encoding the reverb features. In some examples, the audio input to the reverb encoder includes the same noisy input audio processed by the feature cleaner component such that the reverb features extracted by the reverb encoder retain the characteristics of reverberation in the noisy input audio. In other examples, the audio input to the reverb encoder is different than the noisy input audio processed by the feature cleaner component such the reverb features extracted by the reverb encoder condition the vocoder model to swap the characteristics of reverberation in the noisy input audio with characteristics of reverberation in the different audio. Additionally, the architecture of the SR model can be adapted to include a stack of at least two reverb encoders each configured to extract respective reverb features from respective ones of different audio inputs and the sum of the at least two respective reverb features can condition the vocoder model to generate new reverb characteristics in the output audio waveform. In some examples, a user may provide spatial perception inputs that specify a target spatial perception for the output audio waveform to include by mixing the at least two reverb features extracted from the respective ones of the different audio inputs.

Notably, the reverb features extracted by the reverb encoder must only contain information about reverberation, and thus, omit any information related to speech content, such as speaker characteristics and/or linguistic content, as well as omit information related to any other sound quality degradation factors, such as noise or codec artifacts. By contrast, the clean audio features encoded by the feature cleaner component must retain all information present in the noisy input audio that is related to speech (e.g., speaker characteristics and/or linguistic content) while omitting all sound quality degradation factors (e.g., noise, codec artifacts, and reverberation). The vocoder model generates output audio waveforms free of any kind of audio degradation when the reverb encoder passes a zero vector as the reverb feature, and generates output audio waveforms containing characteristics of reverberation specified by reverb features from the reverb encoder when the reverb features include vectors other than the zero vector.

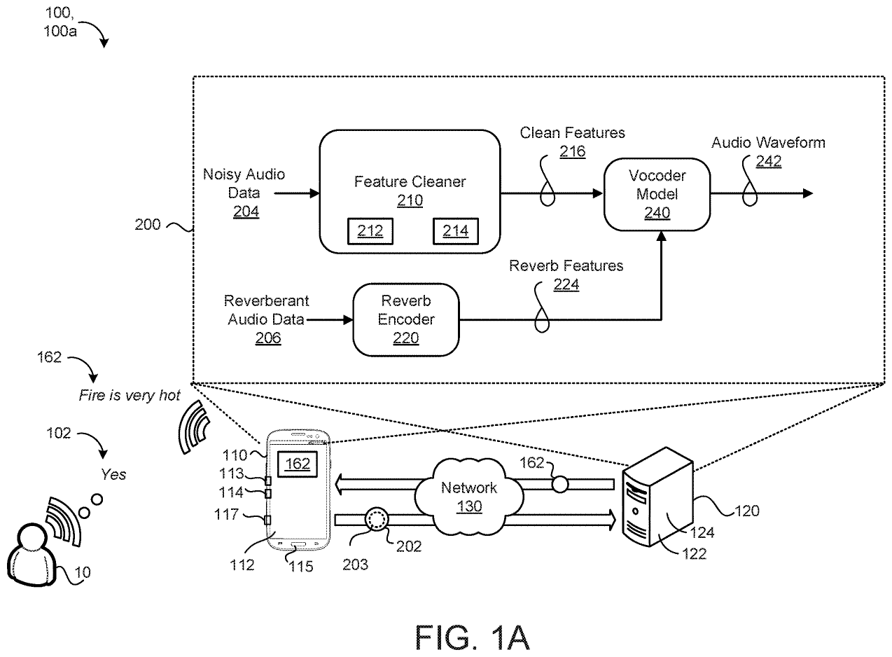

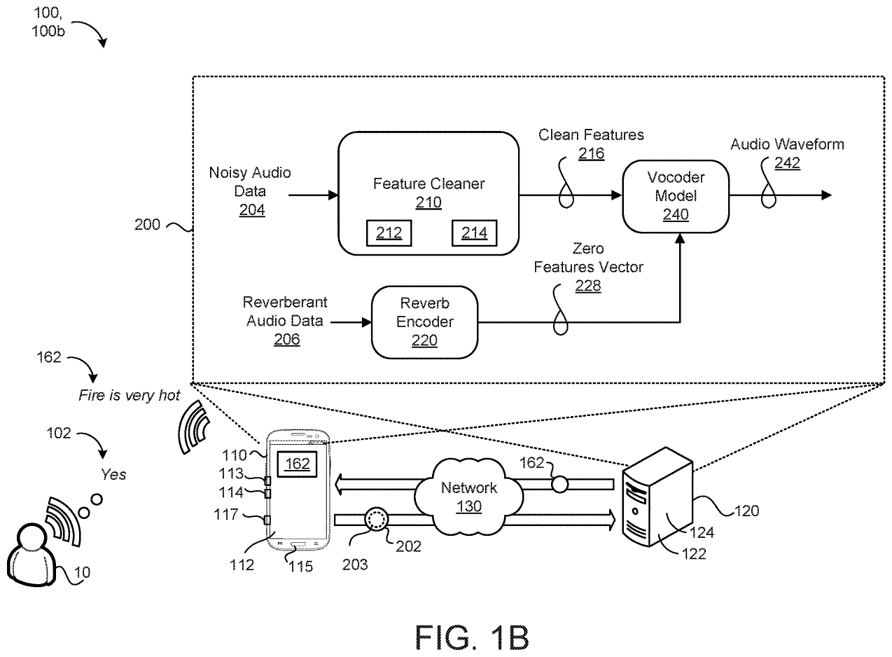

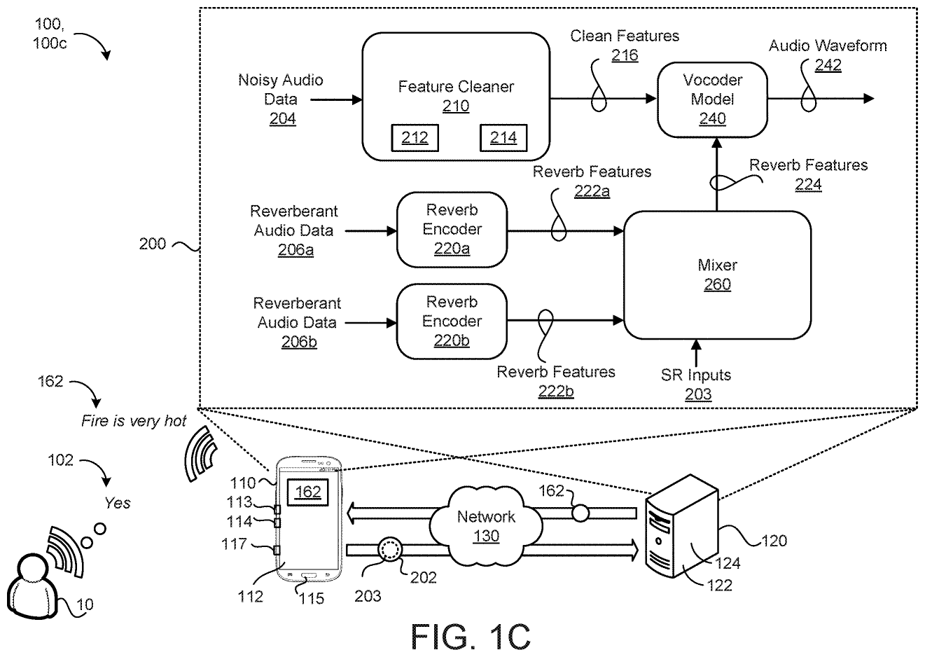

Referring to FIGS. 1A-1C, in some implementations, a system 100 includes a remote computing system 120 in communication with a user device 110 associated with a respective user 10 via a network 130, such as the Internet, a local area network (LAN), a wide area network (WAN), a cellular network, or a wireless network. The remote computing system 120 may be a single computer, multiple computers, or a distributed system (e.g., a cloud environment) having scalable/elastic resources including computing resources 122 (e.g., data processing hardware) and/or storage resources 124 (e.g., memory hardware). The remote computing system 120 is configured to communicate with the user device 110 via the network 130.

The user device 110 may correspond to any computing device, such as a desktop workstation, a laptop workstation, or a mobile device (i.e., a smart phone). The user device 110 includes computing resources 113 (e.g., data processing hardware) and/or storage resources 114 (e.g., memory hardware). The user device 110 may also include an audio input device (e.g., a microphone) 115 and an audio output device (e.g., a speaker) 117 for capturing and playing audio data, respectively. The user device 110 may further include a display device (e.g., a screen) 112 for presenting sound restoration (SR) information to the user 10.

The remote computing system 120 and/or the user device 110 may execute a SR model 200 that provides the capability to control reverberation in modified audio waveforms 242 output by the SR model 200 from original input audio data 202 in a manner independent of removing other noise factors such that existing reverberation that was present in input audio data 202 can be preserved in the modified audio waveform 242, the existing reverberation can be replaced with different reverberation in the modified audio, or new reverberation appropriate for a context of the modified audio can be synthesized. In some examples, the user 10 may speak an utterance 102, such as “Yes”, that is converted into the input audio data 202. The input audio data 202 includes noisy audio data 204 and the reverberant audio data 206. The noisy audio data 204 may be interchangeably referred to as “noisy input audio” and may contain sound degradation factors including noise and characteristics of reverberation. The reverberant audio data 206 may contain characteristics of reverberation. The output audio waveform 242 may be output from the user device 110 as synthetic speech 162. For instance, the synthetic speech 162 may be “Fire is very hot.”

In some examples, the remote computing system 120 executes the SR model 200. In other examples, the user device 110 executes the SR model 200. In yet other examples, some components of the SR model 200 execute on the remote computing system 120 while other components of the SR model 200 execute on the user device 110.

The SR model 200 includes a feature cleaner component 210, a vocoder model 240, and a reverb encoder 220. The feature cleaner component 210 includes an audio encoder 212 and a parallel adapter module 214. The audio encoder 212 may be pre-trained on a vast amount of audio data via an unsupervised or self-supervised pre-training process. The vast amount of audio data may include various types of audio including, but not limited to, real-world noisy data, simulated noisy data, and dry sources that do not contain any sound degradation features. For instance, pre-training process may include wav-2-vec, BEST-RQ, or other unsupervised/self-supervised pre-training process. The audio encoder 212 may include a plurality of multi-head attention layers such as, without limitation, Conformer layers or Transformer layers. In some examples, the audio encoder 212 includes a Universal Speech Model (USM) encoder. The feature cleaner component 210 implements the parallel adapter module 214 to adapt the pre-trained audio encoder 212 to extract clean audio features 216 from noisy input audio 204 that removes sound quality degradation factors such as noise and reverberation present in the noisy input audio 204. The original input audio data 202 may include the noisy input audio 204. The reverb encoder 220 is utilized in parallel with the feature cleaner component 210 and is configured to extract reverb features 224 that retain the characteristics of reverberation from reverberant audio data 206. The original input audio data 202 may include the reverberant audio data 206. The reverberant audio data 206 may include the same audio data as the noisy input audio 204 or different audio data than the noisy input audio 204. In some examples, the characteristics of reverberation contained in the reverberant audio data 206 are different than the characteristics of reverberation present in the noisy audio data 204. The reverb encoder 220 may include a plurality of multi-head attention layers or self-attention layers such as, without limitation, Conformer layers or Transformer layers.

Referring now specifically to FIG. 1A, in a first example system 100, 100a the vocoder model 240 is configured to receive the clean audio features 216 encoded by the audio encoder 212 and the reverb features 224 predicted by the reverb encoder 220 such that the reverb features 224 condition the vocoder model 240 to generate the output audio waveform 242 that removes the sound quality degradation factors present in the noisy input audio 204 while retaining characteristics of reverberation present in the reverberant audio data 206.

Referring now specifically to FIG. 1B, in a second example system 100, 100b, when a target context for the output audio waveform 242 to be generated by the vocoder model 240 is to remove all reverberation, the reverb encoder 220 simply outputs a zero feature vector 228 instead of encoding the reverb features 224. The user 10 may provide spatial perception inputs (e.g., SR inputs) 203 to instruct the SR model 200 to switch between conditioning the vocoder model 240 to generate output audio waveforms 242 that retrain reverberation characteristics specified by reverb features 224 extracted by the reverb encoder 220 (FIG. 1A) or conditioning the vocoder model 240 on the zero feature vector 228 from the reverb encoder 220 to cause the vocoder model 240 to generate output audio waveforms 242 that remove all reverberation (FIG. 1B).

Referring now specifically to FIG. 1C, in a third example system 100, 100c the SR model 200 is adapted to include a stack of at least two reverb encoders 220 each configured to extract respective reverb features 222 from respective ones of different reverberant audio data 206 and the sum of the at least two respective reverb features 222 represents at least a portion of the reverb features 224 that condition the vocoder model 240 to generate new reverb characteristics in the output audio waveform 242. For instance, the stack of at least two reverb encoders 220 may include a first reverb encoder 220, 220a and a second reverb encoder 220, 220b. Here, the first reverb encoder 220a extracts first reverb features 222, 222a from first reverberant audio data 206, 206a and the second reverb encoder 220b extracts second reverb features 222, 222b from second reverberant audio data 206, 206b.

In some examples, the SR model 200 includes a mixer 260 that that sums the at least two respective reverb features 222a, 222b to output reverb features 224. In some examples, the vocoder model 240 receives the reverb features 224 that include at least a portion of the at least two respective reverb features 222a, 222b. As in FIGS. 1A and 1B, the output audio waveform 242 generated by the vocoder model 240 removes all sound degradation factors present in the noisy data input 204 while including the new reverb characteristics present in at least one of the reverberant audio data 206a, 206b. In some examples, the user 10 may provide spatial perception inputs 203 that specify a target spatial perception for the output audio waveform 242 to include by mixing the at least two reverb features 222a, 222b extracted from the respective ones of the different reverberant audio data 206a, 206b. The mixer 260 may generate the reverb features 224 further based on the spatial perception inputs 203.

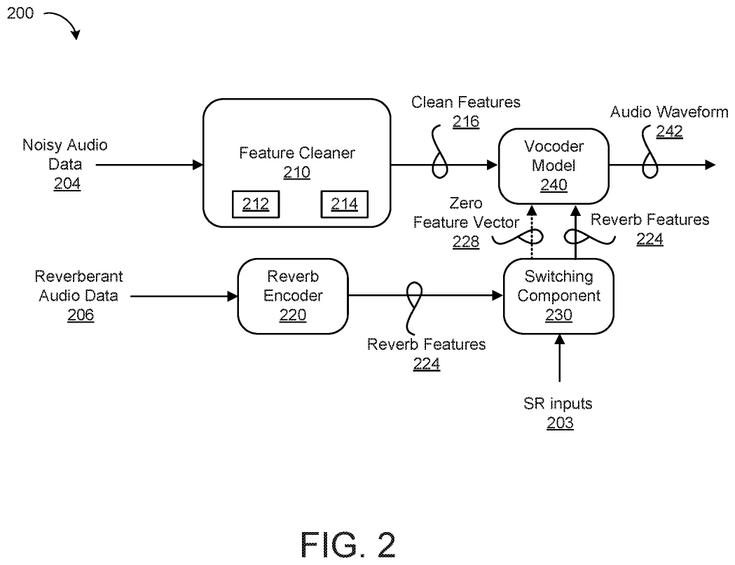

FIG. 2 shows a schematic view of the SR model 200 having the capability to control reverberation in an output audio waveform 242 that removes other sound degradation features such as noise and codec artifacts from noisy input audio 204. The noisy input audio 204 provided as input to the audio encoder 212 and the reverberant audio data 206 provided as input to the reverb encoder 220 may include 16 kHz noisy audio data having 128 dimensional mel filterbanks. The audio encoder 212 may include a plurality of multi-head attention layers such as, without limitation, Conformer layers or Transformer layers. In some examples, the audio encoder 212 includes a Universal Speech Model (USM) encoder. The SR model 200 includes a switching component 230 that selectively conditions the vocoder model 240 between reverb features 224 (i.e., non-zero vectors 224) so that the output audio waveform 242 retains reverberation characteristics (e.g., 24 kHz reverb waveform) specified by the reverb features 224 and zero feature vectors 228 (i.e., zero vectors 228) so that the output audio waveform 242 does not retain any reverberation (e.g., 24 kHz restored waveform). In some examples, the vocoder model 240 receives the reverb features 224 and conditions the clean audio features 216 on reverb features 224 to generate the output audio waveform 242, In some examples, the vocoder model 240 receives the zero feature vector 228 in lieu of the reverb features 224 and generates the output audio waveform 242 based on the clean audio features 216.

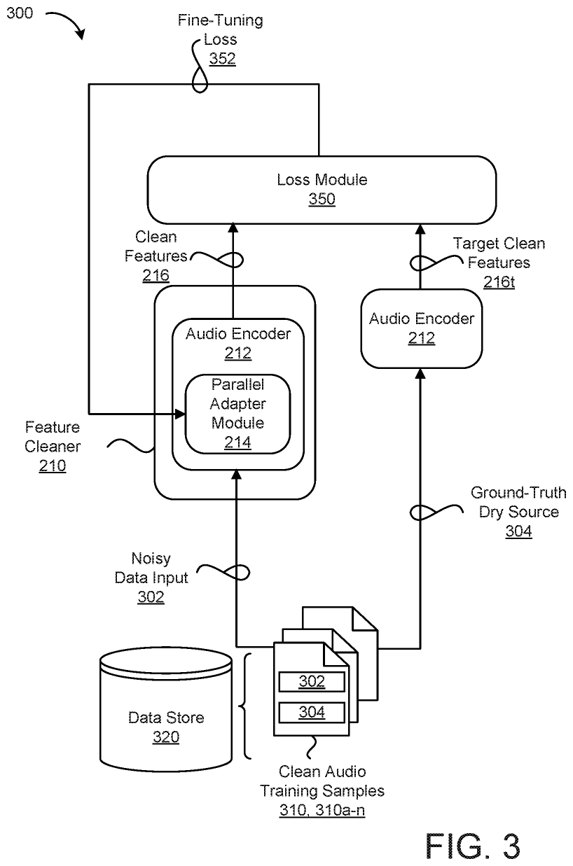

The feature cleaner component 210 undergoes a fine-tuning process 300 (FIG. 3) in which the feature cleaner component 210 is trained on a plurality of clean audio training samples 310, 310a-n (FIG. 3) that each include a simulated noisy data input 302 paired with a corresponding ground-truth dry source 304. Here, the fine-tuning process 300 trains the feature cleaner component 210 to learn how to predict/extract clean audio features 216 (e.g., restored 1536 dimensional features) corresponding to the ground-truth dry source 304 from the simulated noisy data input 302 by only updating parameters of the adapter module 214 while parameters of the pre-trained audio encoder 212 are held fixed. The fine-tuning process 300 is described in greater detail below with reference to FIG. 3.

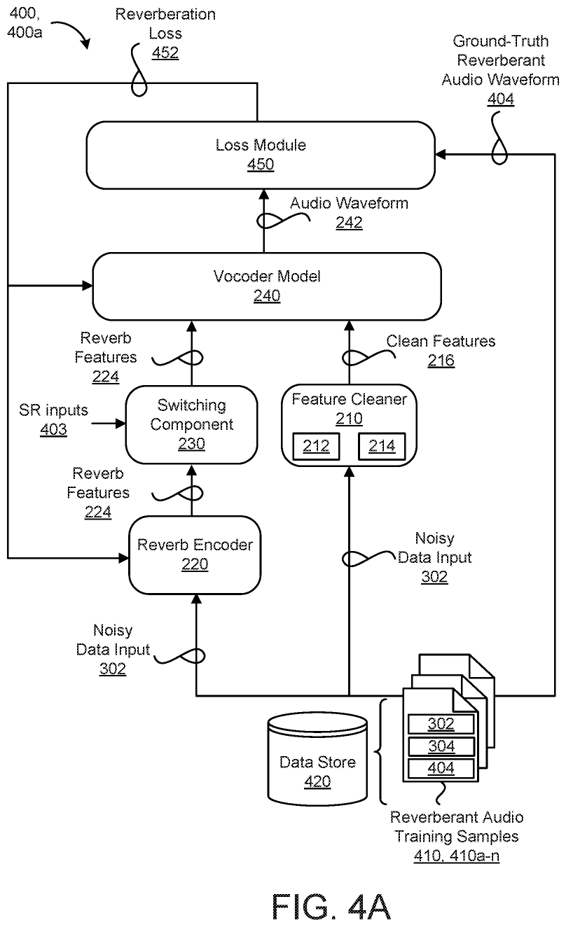

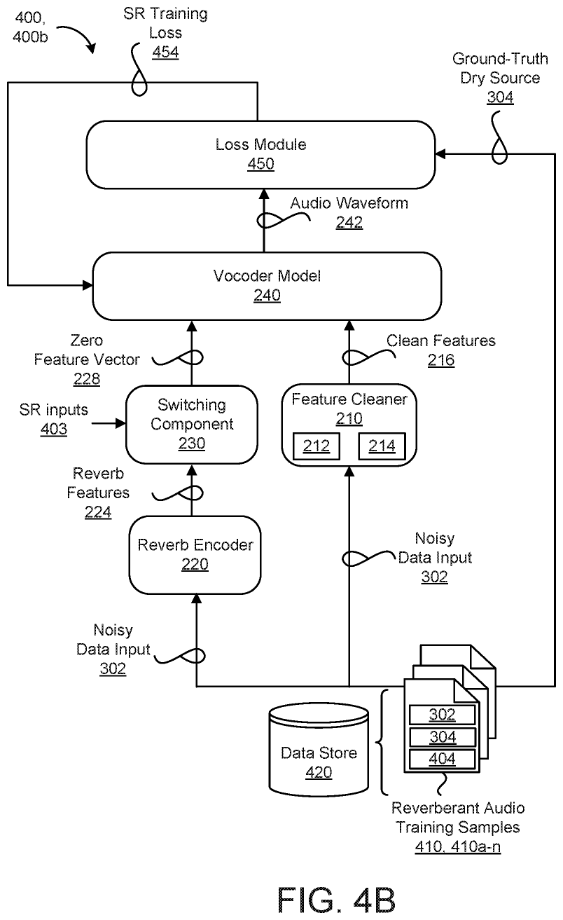

After the fine-tuning process 300 trains the feature cleaner component 210 to learn how to predict/extract the clean audio features 216 (e.g., restored 1536 dimensional features) corresponding to the ground-truth dry source 304, a reverberation training process 400 (FIGS. 4A and 4B) trains the entire SR model 200 to learn how to generate output audio waveforms 242 that remove sound quality degradation factors present in the input audio data 202 with the capability to control characteristics of reverberation in the output audio waveforms 242. In addition to the simulated noisy data inputs 302 paired with the corresponding ground-truth dry sources 304 that form the plurality of clean audio training samples 216 used by the fine-tuning process 300, the reverberation training process 400 is further trained on ground-truth reverberant audio waveforms 404 each paired with a corresponding simulated noisy input 302 by convolving the corresponding ground-truth dry source 304 with a room impulse response (RIR). Here, the reverberation training process 400 provides each simulated noisy data input 302 into the reverb encoder 220 to extract a corresponding reverb feature 224, and next, for each corresponding noisy data input 302 in a mini-batch, one of the corresponding ground-truth dry source 304 or the corresponding ground-truth reverberant audio waveform 404 paired with the corresponding noisy input 302 is randomly chosen as the target for the vocoder model 240 to generate as output.

A training data creation process creates/generates the simulated noisy data inputs 302 and ground-truth reverberant audio waveforms 404 from each ground-truth dry source 304. Each ground-truth dry source 304 includes high-quality audio data recorded in environments such as studios and does not contain any sound quality degradation factors such as noise, codec artifacts, and reverberation. Notably, the objective of a conventional SR system is to predict only the ground-truth dry source from noisy inputs. The training data creation process may create each simulated noisy data input 302 artificially by adding sound quality degradation to a corresponding ground-truth dry source 304 by adding reverberation via convolving the dry source 304 with RIR, adding noise, and applying signal processing-based sound quality degradation such as codec artifacts or bandpass filtering. Accordingly, each ground-truth dry source 304 and the corresponding simulated noisy data input 302 created from the ground-truth dry source 304 by the training data creation process forms a corresponding one of the plurality of clean audio training samples 310 used by the fine-tuning process 300 of FIG. 3.

Similarly, the training data creation process may create each ground-truth reverberant audio waveform 404 from a corresponding ground-truth dry source 304 among the plurality of clean audio training samples 310, 310a-n by convolving the corresponding ground-truth dry source dry 304 with RIR. Accordingly, each ground-truth reverberant audio waveform 404 and the simulated noisy data input 302 created from the same corresponding ground-truth dry source 304 by the training data creation process forms a corresponding reverberant audio training sample 410 of a plurality of reverberant audio training samples 410, 410a-n (FIGS. 4A and 4B) used by the reverberation training process 400 of FIGS. 4A and 4B. The plurality of reverberant audio training samples 410 may be stored in a datastore 420.

Referring now to FIG. 3, the fine-tuning process 300 trains the feature cleaner component 210 that includes the pre-trained audio encoder 212 implementing the parallel adapter module 214 to learn how to extract a predicted clean audio feature 216 from each simulated noisy data input 302 that corresponds to the corresponding ground-truth dry source 304. The clean audio training samples 310 may be stored in a datastore 320. Specifically, for each clean audio training sample 310, the pre-trained audio encoder 212 implementing the parallel adapter module 214 extracts a corresponding predicted clean audio feature 216 from the corresponding simulated noisy data input 302 while the pre-trained audio encoder 212 omitting the parallel adapter module 214 extracts a corresponding target clean audio feature 216, 216T from the corresponding ground-truth source 304. Based on the predicted clean audio feature 216 extracted from the simulated noisy data input 302 and the target clean audio feature 216T extracted from the ground-truth source 304, the fine-tuning process 300 determines a fine-tuning loss 352 using a loss module 350 and updates parameters (interchangeably referred to as weights) of the parallel adapter module 214 while parameters of the pre-trained audio encoder 212 are held fixed (i.e., weights of the pre-trained audio encoder 212 are frozen). Accordingly, the fine-tuning process 300 trains the feature cleaner component 210 to learn how to extract predicted clean audio features 216 from the simulated noisy data inputs 302 that correspond the target clean audio features 216T associated with the ground-truth dry sources 304 by only updating parameters of the adapter module 214 while parameters of the pre-trained audio encoder 212 are held fixed.

Referring now to FIGS. 4A and 4B, the reverberation training process 400 trains the entire SR model 200 to learn how to generate output audio waveforms 242 from the vocoder model 240 that retain/preserve characteristics of reverberation from noisy audio data 204 while removing all other sound degradation factors from the noisy audio data 204. The reverberation training process 400 trains the SR model 200 on the plurality of reverberant audio training samples 410, 410a-n. Each reverberant audio training sample 410 includes a corresponding simulated noisy data input 302, a corresponding ground-truth dry source 304 paired with the corresponding noisy data input 302, and a corresponding ground-truth reverberant audio waveform 404. The corresponding ground-truth reverberant audio waveform 404 is derived from the corresponding ground-truth dry source 304 by convolving the corresponding ground-truth dry source 304 with an RIR such that the corresponding ground-truth reverberant audio waveform 404 includes characteristics of reverberation but omits all other sound degradation factors (e.g., noise and/or codec artifacts) that are present in the simulated noisy data input 302. In some examples, the reverberant audio training samples 410 include the same noisy data input 302 and ground-truth dry source 304 pairs as the clean audio training samples 310 but additionally include the ground-truth reverberant audio waveforms 404.

For each reverberant audio training sample 410 in a mini-batch, the reverberant training process 400 randomly switches between teaching the SR model 200 to learn how to generate the ground-truth reverberant audio waveform 404 (FIG. 4A) or the ground-truth dry source 304 (FIG. 4B) from the corresponding simulated noisy data input 302. For instance, the reverberant training process 400a, 400b may select a random number (e.g., “1” or “0”) representing a simulated SR input 403 for each reverberant audio training sample 410 such that the switching component 230 selects the vocoder model 240 to target the ground-truth reverberant audio waveform 404 (FIG. 4A) or the ground-truth dry source 304 (FIG. 4B). Specifically, the switching component 230 may receive the simulated SR input 403 that switches the input to the vocoder model 240 from the reverb features 224 (FIG. 4A) or the zero feature vector 228 that does not include the reverb features 224 (FIG. 4B).

Referring now specifically to FIG. 4A, in a first example reverberant training process 400, 400a, for a corresponding one of the reverberant audio training samples 410 when the reverberant training process 400 randomly selects to target the corresponding ground-truth reverberant audio waveform 404, the feature cleaner component 210 (pre-trained audio encoder 212 and fine-tuned adapter module 214) and the reverb encoder 220 each receiving, as input, the corresponding simulated noisy data input 302. Here, the feature cleaner component 210 extracts a corresponding predicted clean audio feature 216 and the reverb encoder 220 extracts a corresponding reverb feature 224. The clean audio feature 216 and the reverb feature 224 may each include respective encodings or embeddings encoded from the simulated noisy data input 302. The switching component 230 may receive the simulated SR input 403 instructing the vocoder model 240 to receive the reverb features 224. Thereafter, the vocoder model 240 generates a corresponding output audio waveform 242 conditioned on both the corresponding reverb feature 224 extracted from the simulated noisy data input 302 and the corresponding clean audio feature 216 extracted by the feature cleaner component 210. Based on the corresponding output audio waveform 242 output by the vocoder model 240 and the ground-truth reverberant audio waveform 404, the reverberant training process 400 determines a reverberant training loss 452 using a loss module 450 and updates parameters (interchangeably referred to as ‘weights’) of both the reverb encoder 220 and the vocoder model 240 to teach the SR model 200 to generate the output audio waveform 242 from the vocoder model 240 to match the ground-truth reverberant audio waveform 404. That is, the reverberant training process 400 updates the parameters of the reverb encoder 220 and the vocoder model 240 to reduce a value of the reverberant training loss 452. Notably, the parameters (e.g., weights) of both the audio encoder 212 and the adapter module 214 of the feature cleaner component 210 are frozen during the reverberant training process 400.

Referring now to FIG. 4B, a second example reverberant training process 400, 400b randomly selects to target the corresponding ground-truth dry source 304 for a corresponding another one of the reverberant audio training samples 410, the feature cleaner component 210 (pre-trained audio encoder 212 and fine-tuned adapter module 214) receives, as input, the corresponding simulated noisy data input 302 and extracts a corresponding predicted clean audio feature 216. When targeting the ground-truth dry source 304, the switching component 230 causes the vocoder model 240 to generate a corresponding output audio waveform 242 that is conditioned on only the corresponding clean audio feature 216 extracted by the feature cleaner component 210 from the corresponding simulated noisy data input 302 such that the vocoder model 240 is blocked or prevented from being conditioned on any reverberant features 224 extracted from the simulate noisy data input 302 by the reverb encoder 220. For instance, the switching component 230 may receive the simulated SR input 403 that switches the input to the vocoder model 240 from the reverb features 224 (FIG. 4A) to the zero feature vector 228 that does not include the reverb features 224. In some examples, when the reverberant training process 400 randomly selects to target the ground-truth dry source 304, the vocoder model 240 receives the corresponding clean audio feature 216 extracted by the feature cleaner component 210 and the zero feature vector 228 not including the reverb features 224 instead of the reverb features 224 as the conditioning component to generate the output audio waveform 242. Based on the corresponding output audio waveform 242 output by the vocoder model 240 and the ground-truth dry source 304, the reverberant training process 400 determines a SR training loss 454 using the loss module 450 and updates parameters (interchangeably referred to as ‘weights’) of only the vocoder model 240 to teach the SR model 200 to generate the output audio waveform 242 from the vocoder model 240 to match the ground-truth dry source 304. That is, the reverberant training process 400 updates the parameters of only the vocoder model 240 to reduce a value of the SR training loss 454. Notably, the parameters (e.g., weights) of both the audio encoder 212 and the adapter module 214 of the feature cleaner component 210 are frozen during the reverberant training process 400.

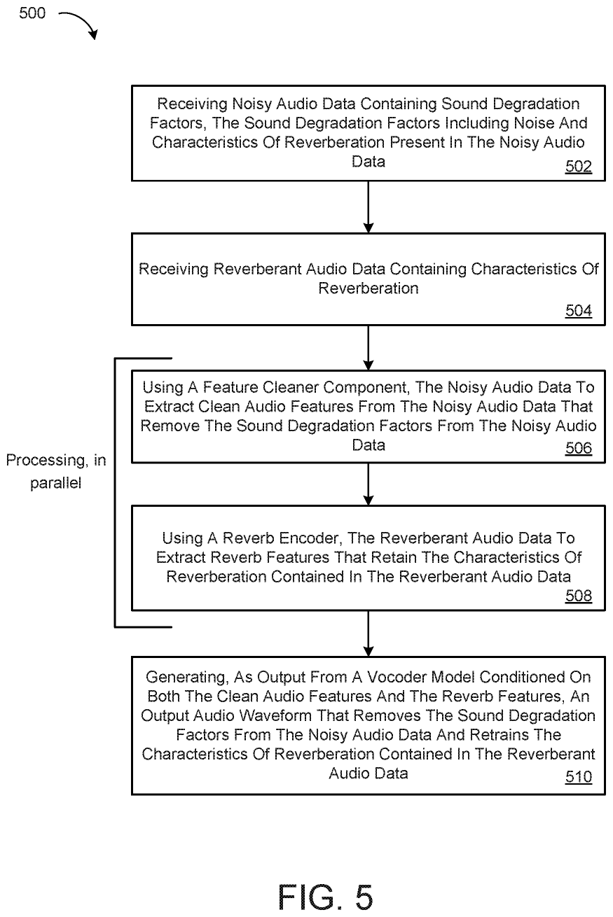

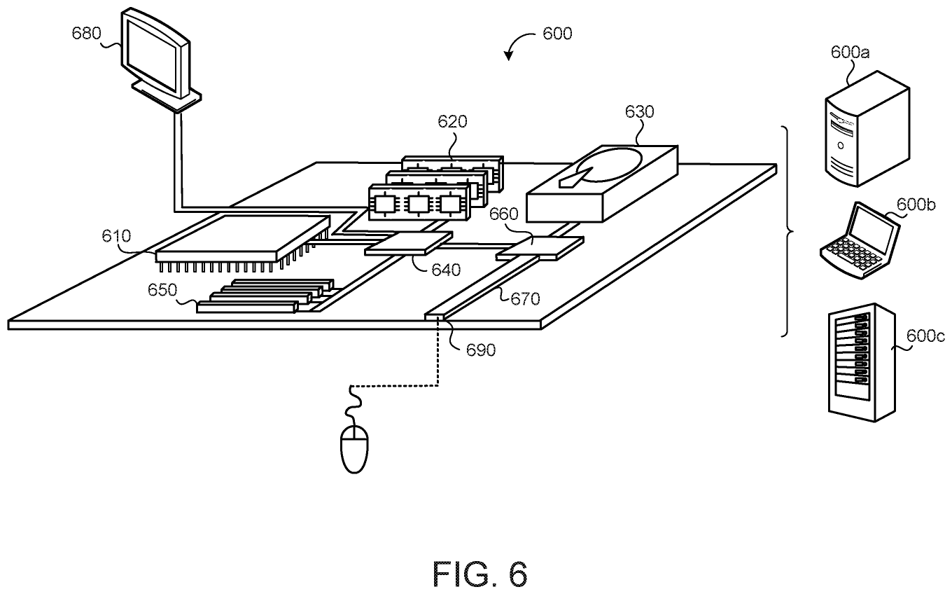

FIG. 5 is a flowchart of an example arrangement of operations for a computer-implemented method 500 for controlling reverberations using the SR model 200. The method 500 may execute on data processing hardware 610 (FIG. 6) using instructions stored on memory hardware 620 (FIG. 6). The data processing hardware 610 and the memory hardware 620 may reside on the user device 110 and/or the remote computing system 120 of FIGS. 1A-1C each corresponding to the computing device 600 (FIG. 6).

At operation 502, the method 500 includes receiving noisy audio data 204 containing sound degradation factors. The sound degradation factors including noise and characteristics of reverberation present in the noisy audio data 204. At operation 504, the method 500 includes receiving reverberant audio data 206 containing characteristics of reverberation. The method 500 processes, in parallel, operations 506 and 508. At operation 506, the method 500 includes processing, using a feature cleaner component 210, the noisy audio data 204 to extract clean audio features 216 from the noisy audio data 204 that remove the sound quality degradation factors from the noisy audio data 204. At operation 508, the method 500 includes processing, using a reverb encoder 220, the reverberant audio data 206 to extract reverb features 224 that retain the characteristics of reverberation contained in the reverberant audio data 206. At operation 510, the method 500 includes generating, as output from a vocoder model 240 conditioned on both the clean audio features 216 and the reverb features 224, an output audio waveform 242 that removes the sound quality degradation factors from the noisy audio data 204 and retains the characteristics of reverberation contained in the reverberant audio data 206.

The SR model 200 provides technical advantages by providing the clean audio features 216 and the reverb features 224 to the vocoder model 240. Notably, the reverb features 224 extracted by the reverb encoder 220 may only contain information about reverberation and omit any information related to speech content, such as speaker characteristics and/or linguistic content, as well as omit information related to any other sound quality degradation factors, such as noise or codec artifacts. By contrast, the clean audio features 216 encoded by the feature cleaner component 210 may retain all information present in the noisy audio data (i.e., noisy input audio) 204 that is related to speech (e.g., speaker characteristics and/or linguistic content) while omitting all sound quality degradation factors (e.g., noise, codec artifacts, and reverberation). The vocoder model 240 may generate output audio waveforms 242 free of any kind of audio degradation when the reverb encoder 220 passes a zero vector 228 as the reverb feature 224, and generates output audio waveforms 242 containing characteristics of reverberation specified by reverb features 224 from the reverb encoder 220 when the reverb features 224 include non-zero vectors 226.

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low-speed interface/controller 660 connecting to a low-speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high-speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 620, the storage device 630, or memory on processor 610.

The high-speed controller 640 manages bandwidth-intensive operations for the computing device 600, while the low-speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
receiving noisy audio data containing sound degradation factors, the sound degradation factors including noise and characteristics of reverberation present in the noisy audio data;
receiving reverberant audio data containing characteristics of reverberation;
processing, in parallel:
using a feature cleaner component, the noisy audio data to extract clean audio features from the noisy audio data that remove the sound degradation factors from the noisy audio data; and
using a reverb encoder, the reverberant audio data to extract reverb features that retain the characteristics of reverberation contained in the reverberant audio data; and
generating, as output from a vocoder model conditioned on both the clean audio features and the reverb features, an output audio waveform that removes the sound degradation factors from the noisy audio data and retains the characteristics of reverberation contained in the reverberant audio data.

2. The method of claim 1, wherein the reverberant audio data comprises the same audio data as the noisy audio data.

3. The method of claim 1, wherein the reverberant audio data comprises different audio data than the noisy audio data.

4. The method of claim 3, wherein the characteristics of reverberation contained in the reverberant audio data are different than the characteristics of reverberation present in the noisy audio data.

5. The method of claim 1, wherein the reverb encoder comprises a stack of self-attention layers.

6. The method of claim 5, wherein the stack of self-attention layers comprise Conformer layers or Transformer layers.

7. The method of claim 1, wherein the feature cleaner component comprises a pre-trained audio encoder implementing an adapter module to adapt the pre-trained audio encoder to extract the clean audio features from the noisy audio data.

8. The method of claim 7, wherein the pre-trained audio encoder is pre-trained on various types of audio data via an unsupervised or self-supervised pre-training process, the various types of audio data including real-world noisy data, simulated noisy data, and dry sources that do not contain any sound degradation factors.

9. The method of claim 7, wherein a fine-tuning process trains the feature cleaner component by:
obtaining a clean audio training sample comprising a corresponding noisy data input paired with a corresponding ground-truth dry source, the ground-truth dry source removing sound degradation factors present in the noisy data input;
processing, using the pre-trained audio encoder implementing the adapter module, the noisy data input to extract predicted clean features;
processing, using only the pre-trained audio encoder, the ground-truth dry source to extract target clean features;
determining a fine-tuning loss based on the predicted clean features and the target clean features; and
updating parameters of the adapter module while parameters of the pre-trained audio encoder are held fixed to teach the feature cleaner component to extract clean features that match the target clean features.

10. The method of claim 7, wherein the pre-trained audio encoder comprises a stack of multi-head attention layers.

11. The method of claim 7, wherein a reverberation training process trains the feature cleaner component, the reverb encoder, and the vocoder model by:
obtaining a reverberant audio training sample comprising a corresponding noisy data input, a corresponding ground-truth dry source that removes sound degradation factors present in the noisy data input, and a ground-truth reverberant audio waveform derived from the ground-truth dry source by convolving the ground-truth dry source;
processing, using the pre-trained audio encoder implementing the adapter module, the noisy data input to extract clean features from the noisy data input;
processing, using the reverb encoder, the noisy data input to extract reverb features from the noisy data input;
generating, as output from the vocoder model conditioned on both the clean features and the reverb features, an output training audio waveform;
determining a reverberation loss based on the output training audio waveform and the ground-truth reverberant audio waveform; and
updating parameters of the reverb encoder and the vocoder model based on the reverberation loss.

12. A system comprising:
data processing hardware; and
memory hardware in communication with the data processing hardware, the memory hardware storing instructions that when executed on the data processing hardware cause the data processing hardware to perform operations comprising:
receiving noisy audio data containing sound degradation factors, the sound degradation factors including noise and characteristics of reverberation present in the noisy audio data;
receiving reverberant audio data containing characteristics of reverberation;
processing, in parallel:
using a feature cleaner component, the noisy audio data to extract clean audio features from the noisy audio data that remove the sound degradation factors from the noisy audio data; and
using a reverb encoder, the reverberant audio data to extract reverb features that retain the characteristics of reverberation contained in the reverberant audio data; and
generating, as output from a vocoder model conditioned on both the clean audio features and the reverb features, an output audio waveform that removes the sound degradation factors from the noisy audio data and retains the characteristics of reverberation contained in the reverberant audio data.

13. The system of claim 12, wherein the reverberant audio data comprises the same audio data as the noisy audio data.

14. The system of claim 12, wherein the reverberant audio data comprises different audio data than the noisy audio data.

15. The system of claim 14, wherein the characteristics of reverberation contained in the reverberant audio data are different than the characteristics of reverberation present in the noisy audio data.

16. The system of claim 12, wherein the reverb encoder comprises a stack of self-attention layers.

17. The system of claim 16, wherein the stack of self-attention layers comprise Conformer layers or Transformer layers.

18. The system of claim 12, wherein the feature cleaner component comprises a pre-trained audio encoder implementing an adapter module to adapt the pre-trained audio encoder to extract the clean audio features from the noisy audio data.

19. The system of claim 18, wherein the pre-trained audio encoder is pre-trained on various types of audio data via an unsupervised or self-supervised pre-training process, the various types of audio data including real-world noisy data, simulated noisy data, and dry sources that do not contain any sound degradation factors.

20. The system of claim 18, wherein a fine-tuning process trains the feature cleaner component by:
obtaining a clean audio training sample comprising a corresponding noisy data input paired with a corresponding ground-truth dry source, the ground-truth dry source removing sound degradation factors present in the noisy data input;
processing, using the pre-trained audio encoder implementing the adapter module, the noisy data input to extract predicted clean features;
processing, using only the pre-trained audio encoder, the ground-truth dry source to extract target clean features;
determining a fine-tuning loss based on the predicted clean features and the target clean features; and
updating parameters of the adapter module while parameters of the pre-trained audio encoder are held fixed to teach the feature cleaner component to extract clean features that match the target clean features.

21. The system of claim 18, wherein the pre-trained audio encoder comprises a stack of multi-head attention layers.

22. The system of claim 18, wherein a reverberation training process trains the feature cleaner component, the reverb encoder, and the vocoder model by:
obtaining a reverberant audio training sample comprising a corresponding noisy data input, a corresponding ground-truth dry source that removes sound degradation factors present in the noisy data input, and a ground-truth reverberant audio waveform derived from the ground-truth dry source by convolving the ground-truth dry source;
processing, using the pre-trained audio encoder implementing the adapter module, the noisy data input to extract clean features from the noisy data input;
processing, using the reverb encoder, the noisy data input to extract reverb features from the noisy data input;
generating, as output from the vocoder model conditioned on both the clean features and the reverb features, an output training audio waveform;
determining a reverberation loss based on the output training audio waveform and the ground-truth reverberant audio waveform; and
updating parameters of the reverb encoder and the vocoder model based on the reverberation loss.
